(19) United States
(12) Patent Application Publication
(10) Pub. No.: US 2011/0056966 A1
(43) Pub. Date: Mar. 10, 2011

(54) Fuel Tank Attachment And Method For Producing A Fuel Tank Attachment

(75) Inventors: Reinhard Feichtinger, Pleinfeld-Ramsberg (DE); Simon Amesöder, Nurnberg (DE)

(73) Assignee: Reinhard, Pleinfeld-Ramsberg (DE)

(21) Appl. No.: 12/530,967

(22) PCT Filed: Mar. 19, 2008
(86) PCT No.: PCT/EP08/53288

§ 371 Date: Nov. 12, 2009

(30) Foreign Application Priority Data
Mar. 21, 2007 (DE) 10 2007 013 472.1

(51) Int. Cl. B65D 25/00; B29C 65/48; B29C 45/16

(52) U.S. Cl. 220/694; 156/308.2; 156/272.6; 156/245

(57) ABSTRACT

The invention relates to a fuel tank attachment comprising a first region (12) that has a first plastic (A), and a second region (35), wherein the second region has a blend of the first plastic and a second plastic (B), wherein the first and second plastics are not miscible, wherein the blend contains a compatibilizer to make the first and second plastics miscible, wherein the first and the second regions are integrally bonded to each other, wherein the first plastic is a fuel-resistant plastic, and wherein the second plastic is a non-fuel-resistant plastic.

The invention relates to a fuel tank attachment, a fuel tank, in particular, a motor-vehicle fuel tank, and to a method of producing a fuel tank attachment.

DE 195 35 413 C1 discloses a component that is composed of a tubular thermo-plastic body that has a stepped annular body at one end and a retaining ridge at the opposite end. Opposite the inner diameter of the body, a circular ring with a projection is molded on, offset by the wall thickness of the body. An intermediate layer functioning as an adhesion promoter is incorporated in the stepped annular body. Under this, an annular body element is molded on enclosing the ring with the projection. When heated, the annular body element, intermediate layer, and circular ring of the tubular body are joined to each other in addition to the mechanical connection that is effected by the circular projection.

Since this type of attachment does not withstand swelling by the plastics, the plastic of the annular body element, according to DE 100 62 997 A1, is cross-linked in such a way that a chemical bond is created between the plastics of both parts by means of bridging across the interface between the parts. At its end pointing towards the tank, the tubular body is divided into an inner tubular body and an outer tubular body.

The inner tubular body here projects into the opening through half the wall thickness of the tank. The outer tubular body at least partially encloses the annular body element. The annular body element here is of an interior diameter that is larger than the diameter of the opening.

A disadvantageous aspect of the two known solutions is the fact that the connection between the tubular body and annular body element is expensive in terms of material and cost.

In contrast, the fundamental problem to be solved by the invention is to create an improved fuel tank attachment, a fuel tank, and a method of producing a fuel tank attachment.

The fundamental problems of the invention are solved by each of the features of the independent claims. Embodiments of the invention are provided in the dependent claims.

Embodiments of the invention in particular have the advantage that the fuel tank attachment can be produced cost-effectively and can be attached to the fuel tank in an operationally reliable manner.

What is meant here by “fuel tank attachment” are all those components that are suitable for installation on a fuel tank, in particular, filler necks, valves, in particular, tank venting valves, closing elements, or the like.

In a first embodiment of the invention, the fuel tank attachment has a first region that has a first plastic. After installation of the fuel tank attachment on a fuel tank, the first region is exposed at least temporarily to the fuel. The first plastic therefore involves a fuel-resistant plastic. What is meant by a fuel-resistant plastic here is a plastic that does not swell, or swells very little, when exposed to a fuel or oil for an extended period of time.

A possible first fuel-resistant plastic may, for example, be polyamide (PA), in particular, PA 12, or polyoxymethlene (POM). However, the first plastic may also be another fuel-resistant thermoplastic or a fuel-resistant blend of compatible plastics.

The fuel tank attachment has at least one second region that normally does not come into direct contact with the fuel. The second region is composed of a blend of the first plastic and the second plastic. The second plastic is a non-fuel-resistant plastic.

What is meant by a “non-fuel-resistant” here is a plastic that swells or is otherwise significantly modified in terms of its dimensions or mechanical properties whenever it comes into contact with fuel for an extended period of time. For example, this second non-fuel-resistant plastic may be polyethylene (PE) or polypropylene (PP). However, it may also be another non-fuel-resistant thermoplastic or a blend of compatible plastics that are not fuel-resistant.

The first and second plastic are not miscible per se. The blend therefore contains a compatibilizer so as to make the first and second plastics miscible.

The first and second regions are integrally bonded to each other. For example, the integral bond may be a weld. The integral bond may also be generated by two-component or multi-component plastic injection-molding.

The integral bond between the first region that has the first plastic and the second region that has, among other things, the second plastic which is not miscible with the first plastic is enabled by the fact that the second region also contains the first plastic in addition to the second plastic.

This is in particular advantageous in terms of reducing the cost of the fuel tank attachment. This is because the first fuel-resistant plastic is generally significantly more expensive that the second, non-fuel-resistant plastic. Since, however, the first and second plastics are not miscible, and thus normally no integral fluid-tight bond can be created between the two plastics, in the prior art the fuel tank attachment will generally be composed only of the first plastic, which approach is accordingly expensive.

This is where the invention provides a remedy by providing an approach wherein only those first regions of the fuel tank attachment are produced from the first plastic which are exposed to the fuel in normal operation, i.e., after mounting on the fuel tank and filling the fuel tank with fuel, whereas, on the other hand, one or more second regions that are normally not exposed to the fuel are produced from the blend that has only a certain proportion of the first plastic so as to provide an integral bond with the first regions.

In addition, embodiments of the invention also have mechanical advantages: The second region can be joined to the first region by means of a first joining surface. The second region, in turn, can be joined to a third region by means of a second joining surface, where, e.g., the third region may be the outer wall of the fuel tank. Joining the first region to the third region is thus effected by means of two joining surfaces. This has the advantage that the mechanical stress within the joining surfaces is relatively low, with the result that an especially operationally-reliable system is created.

Specifically, the materials which follow each other in succession from the first region to the third region have graduated properties: First of all, the first region, that composed, e.g., of PA, has the highest base stiffness. The second region, which is composed of the blend, has a lower stiffness than the first region, while the third region, that composed, e.g., of PE, has the lowest base stiffness.

The situation is exactly reversed in terms of the swelling behavior of the various regions: The first region composed of fuel-resistant plastic has the lowest swelling behavior, the second region has a medium-level swelling behavior, while the third region composed of non-fuel-resistant plastic has the greatest swelling behavior. The first region thus swells the least upon contact with the fuel, while the third region swells the most. This graduated swelling behavior corresponds to the graduated base stiffnesses and results in an overall reduction in the mechanical load on the joining surfaces.

In one embodiment of the invention, the compatibilizer is a copolymer of the first and second plastics. The use of this compatibilizer has in particular the advantage that it is not necessary to incorporate any further additional material different from the first and second plastics into the blend. This is because such an additional material could be problematic in terms of its impermeability and long-term durability.

In one embodiment of the invention, the polymer involves a “graft copolymer.” What is meant by a “graft copolymer is a copolymer that is produced as follows: To produce the graft copolymer, one of the first and second plastics is grafted such that the grafted plastic can then enter into covalent bonds with the other of the two plastics. The grafting of the plastic is effected, for example, with a reactive group, such as, for example, a maleic anhydride or a acetic acid group. In the blend of the first and second plastics, the copolymer then acts as a emulsifier.

In one embodiment of the invention, the copolymer is produced by means of an additional compatibilizer that is added in solid or liquid form to a blend of the first and second plastics, and is at least partially consumed during copolymerization. The additional compatibilizer her reacts both with the first as well as the second plastic.

In one embodiment of the invention, the additional compatibilizer contains reactive isocyanate groups and/or oligomers with epoxide groups and/or (maleic-acid) anhydride groups or oxazoline groups.

In one embodiment of the invention, the proportion of the first plastic in the blend is smaller than the proportion of the second plastic. For example, the proportion of the first plastic may be a maximum of 35 wt. %, in particular between 20 wt. % and 30 wt. %

In one embodiment of the invention, the second region is designed for an integral bond with a third region, where the third region is located on an outer wall of a fuel tank. For example, the third region is composed of the second plastic, with the result that the integral bond is able to be created due to the presence of the second plastic in the blend.

The problem to be solved is therefore to further develop a component composed in part of a thermoplastic material of the type referenced in the introduction so that it is simple to produce and can be reliably joined to a tank that is predominantly composed of a different thermoplastic material.

In embodiments of the invention, it is especially advantageous if the fuel tank attachment can be composed essentially of two main elements—specifically, a tubular body element with an annular body element located a certain distance from a tubular outlet opening, i.e. a first component composed of the first plastic, and a flange body, i.e., a second component composed of the blend. Both parts can be produced easily and cost-effectively, and can be subsequently easily joined in a fluid-tight manner. Due to the fact that the spacing of the tubular outlet opening disposed on the tubular body element is greater than the thickness of the flange body, the tubular body element projects into the opening of the tank. The tubular body element is thus seated like a cork in the opening, thereby enabling it to withstand mechanical loads, principally laterally-directed forces.

The fuel tank attachment can, for example, perform a function such as a filler neck, tank venting valve, closing element, or the like. In various applications, the attachment operation is effected in the same way whereby in all embodiments the annular body element and tubular body element are essentially of identical design and are essentially composed of the same thermoplastic material, while the flange body also of essentially identical design, is implemented as an adapter so as to enable a fluid-tight and gas-tight connection to be created both with the specific component and also with the tank, i.e., the fuel tank. This approach significantly reduces the production and installation costs.

In one embodiment of the invention, a layer can be applied, at least in part, to at least one surface element of the copolymer—flange body, i.e. the second component. This layer additionally reinforces the effective adhesion properties. The layer can thus be applied to the complete surface element or only on a spot basis. Even a layer applied on a spot basis ensures the effectiveness of the adhesion properties. This layer may have a thickness of between approximately 0.001 μm and 100 μm.

This layer can be effected, for example, by plasma coating, such as that known, for example, from DE 102 23 865 A1. The plasma coating can be effected on one joining surface of the copolymer—flange body with a chemically active layer, wherein the layer may comprise, for example, low-molecular-weight polymer fragments.

The copolymer—flange body can be composed of approximately 10 to 85 wt. % polyamide and approximately 85 to 10 wt. % polyethylene, as well as approximately 5 wt. % additives. In particular, an equal ratio of polyamide to polyethylene is possible. How the proportions are distributed depends on the specific application conditions. However, it is also possible for the flange layers to be composed of layers having different mixing ratios.

A polyethylene flange body can be composed of up to approximately 95 wt. % of one polyethylene and approximately 5 wt. % additives. Typical additives can be stabilizers, lubricants, dyes, metal filters, metallic pigments, stamped metal filters, flame retardants, impact-resistance modifiers, antistatic agents, conductivity additives, and the like.

The inner diameter of the flange body may be greater than a diameter of the opening of the tank. This approach enables the attachment region to be at least partially removed from the area of influence of the fuel and its vapors, thereby counteracting the swelling forces.

The annular body element and the tubular body element can be formed individually. The annular body element can then be joined to the tubular body element. However, it is also possible for the annular body element to be formed simultaneously with the tubular body element and molded onto this element. This approach reduces production costs.

Principally for purposes of reducing cost, the tubular body element can be composed of a thermoplastic material that can be coated at least in part with a polyamide body. The thermoplastic material body here can be composed of polyester, polyacetate, polyolefin, fluorothermoplastic, polyphenyl sulfide, or an inexpensive polyamide that has a lower fuel resistance.

A first tubular body element can then terminate in a connection unit at the end facing away from the tank. By using this type of tubular body element, the component can be employed as a filler neck.

At the end facing away from the tank, a second tubular body element can be closed by a cap element. In this form, this type of component can be used as a closure element for non-required openings of the tank.

At least one connecting tubular element can be disposed below the cap element of the second tubular body element. This provides a housing for a tank venting valve into which a valve element can be inserted.

The connection unit and/or the connecting tubular element can terminate in at least one circular connection ridge. This enables a hose to be connected.

In a second aspect, the invention relates to a fuel tank, in particular, a motor-vehicle fuel tank, such as, for example, a fuel tank for an automobile. The fuel tank has an opening and an outer wall that can be composed of the second plastic. The fuel tank attachment is, for example, passed partially through the opening in the fuel tank, and its second region is integrally bonded to the outer wall of the fuel tank—for example, by welding a joining surface of the second region to the outer wall.

In another aspect, the invention relates to a method of producing a fuel tank attachment comprising the following steps: producing a first component from a first plastic, wherein the first plastic is fuel-resistant; producing a second component from a blend of the first plastic with the second plastic, wherein the blend contains a compatibilizer to make the first and second plastics miscible, wherein the second plastic is non-fuel-resistant; and integrally bonding the first and second components.

In one embodiment of the invention, a joining surface of the second region is pretreated before integral bonding so as to enhance the reactivity of the joining surface. This can be effected by a plasma treatment of the joining surface, for example, by means of a plasma jet, such as that known per se from EP 0 986 939 B1. Alternatively or additionally, a pretreatment of the joining surface can be effected by a plasma coating, flame treatment, chemical etching, or a mechanical pretreatment. The reactivity of the joining surface as enhanced by this type of pretreatment is especially advantageous for implementing the integral bond between the first and second components.

In one embodiment of the invention, the integral bond is generated by two-component or multi-component plastic injection molding. To this end, for example, the second component is created by injecting the blend into a mold. The mold is then opened for the purpose of pre-treating a joining surface of the second component—for example, by a plasma treatment or plasma coating. Subsequently, the first component is produced and integrally bonded to the second component by injecting the first plastic into the mold.

Embodiments of the invention are especially advantageous since the molding and joining of the first and second components, that is, for example, a tubular body element and a flange body, can be effected in an especially cost-effective manner.

Advantageously, at least one surface element, in particular, a joining surface, of the flange body can be coated by a plasma, after which the flange body with the plasma-treated surface element is joined in a fluid-tight manner to the annular body element. The coating operation saves material while at the same time enhancing adhesion.

The layer can be generated by two approaches:

In order to generate a first layer, a gas in a gas atmosphere can trigger a discharge that extracts ions from the flange body, atomizes them, accelerates them a short distance, which ions can be directed as a beam onto the surface element.

For this purpose, the discharge can be triggered as a gas from air or components of air, or from an inert gas, or inert gas and combinations thereof. The inert gas may be helium, neon, argon, krypton, xenon, radon, and mixtures and/or combinations thereof.

Components can be contained in a gas in a gas atmosphere that react in an open state with the surface element of the flange body and can form a second layer.

In terms of the gas, components of an organic type can react in air for this purpose. However, components of an inorganic type can also react in air as the gas.

In both cases, a surface element of a flange body or the surface element of a plurality of flange bodies can be treated. Costs are reduced on a sustained basis due to the fact that the treatment can be effected in open conditions, that is, not under a vacuum.

To achieve an additional optimization in material, for the tubular body element a body can first be molded out of a thermoplastic material that can be coated at least in part with a polyamide body. In an approach similar to hot-dip galvanization, the high-cost material is applied to a cost-effective one so as to exploit its predominantly positive properties.

The thermoplastic material can be formed out of polyester, polyacetate, polyolefin, fluorothermoplastic, polyphenyl sulfide, or an inexpensive polyamide that has a relatively low fuel resistance.

A connection unit can be molded onto a first tubular body element at the end facing away from the tank.

A cap element can be molded onto a second tubular body element at the end facing away from the tank. At least one connecting tubular element can be molded on below the cap element of the second tubular body element.

The flange body can then be welded to the tank. Whether a filler neck or blank flange or tank venting valve is considered, all of these components can be welded onto the tank over the openings in a tight manner using the same approach at another location on the tank. As a result, costs incurred in final assembly are reduced.

Embodiments of the invention will be described in more detail with reference to the drawings.

In the drawings:

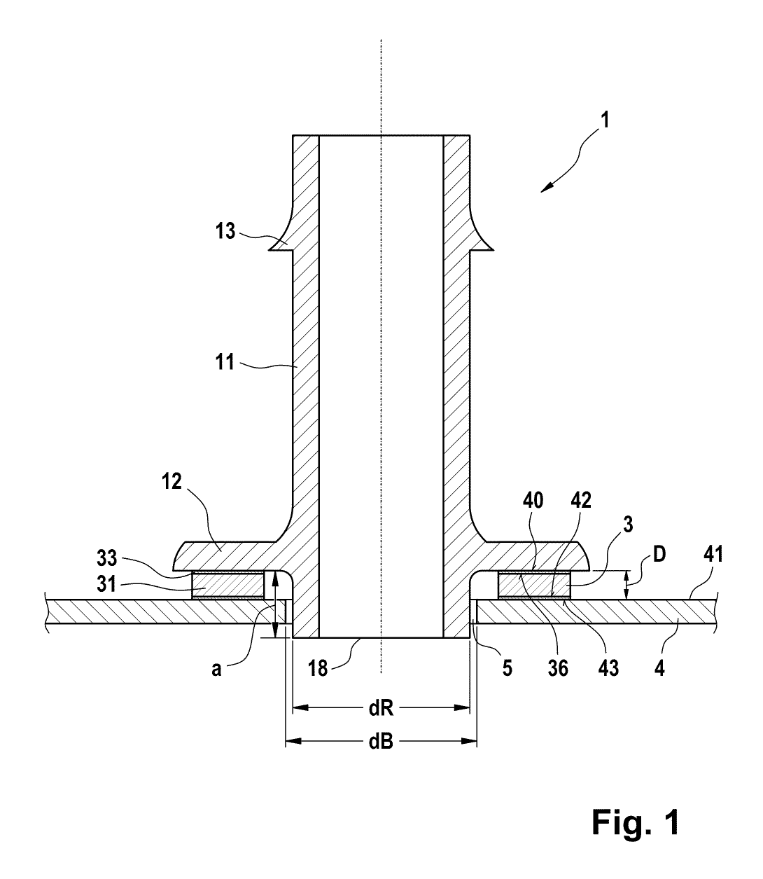

FIG. 1 is a schematic sectional view illustrating a component designed as a filler neck and attached to a tank;

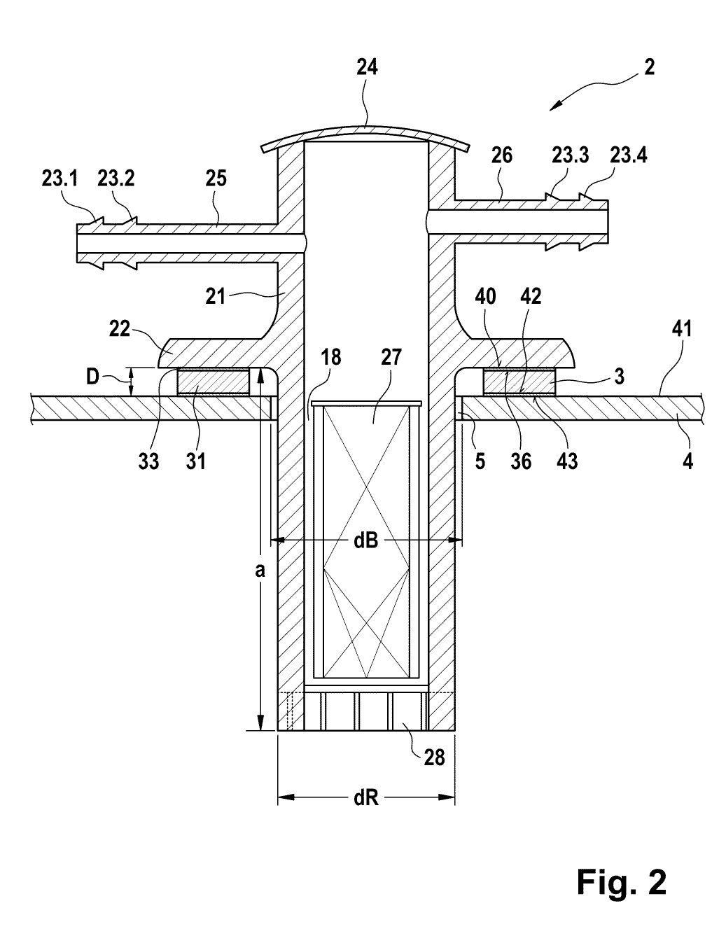

FIG. 2 is a schematic sectional view illustrating a component designed as a tank venting valve and attached to a tank;

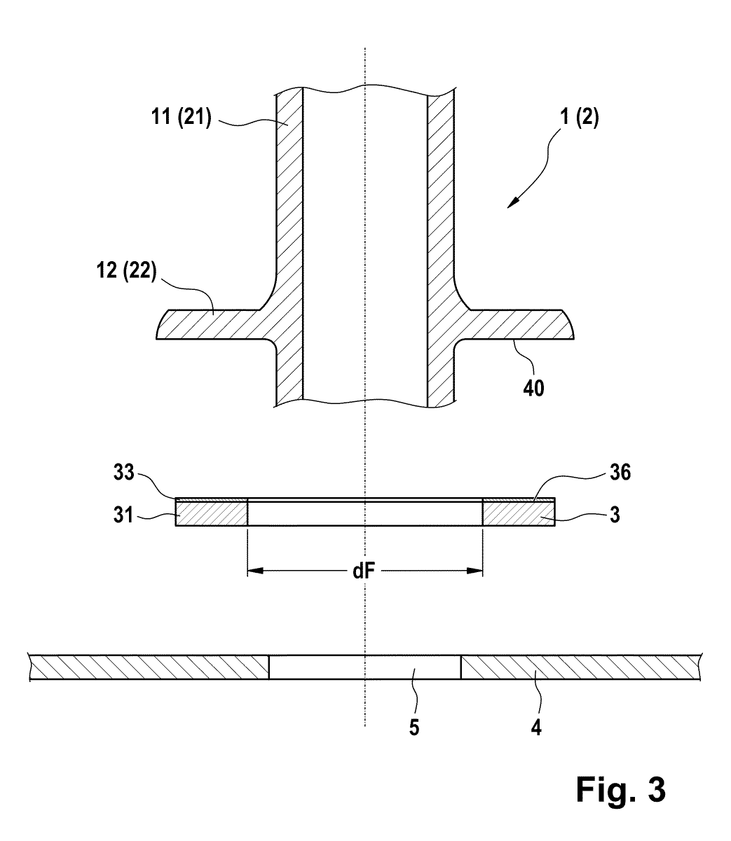

FIG. 3 provides a partial, schematic, disassembled, sectional view illustrating a first embodiment of an attachment of a tubular body element of a filler neck as in FIG. 1 or tank venting valve as in FIG. 2;

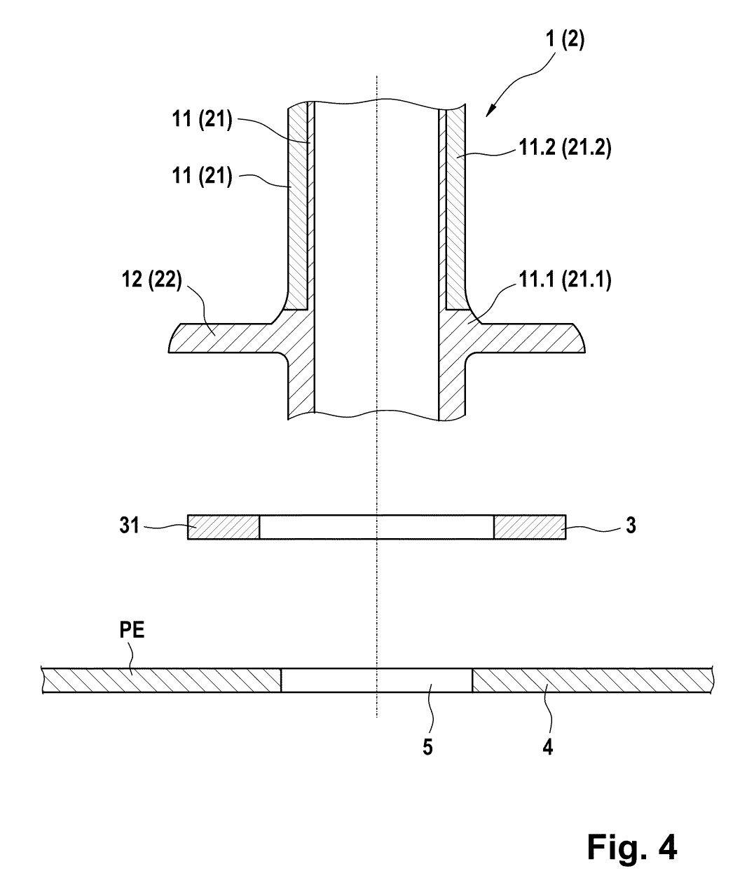

FIG. 4 provides a partial, schematic, disassembled, sectional view illustrating a second embodiment of an attachment of a tubular body element of a filler neck as in FIG. 1 or a tank venting valve as in FIG. 2;

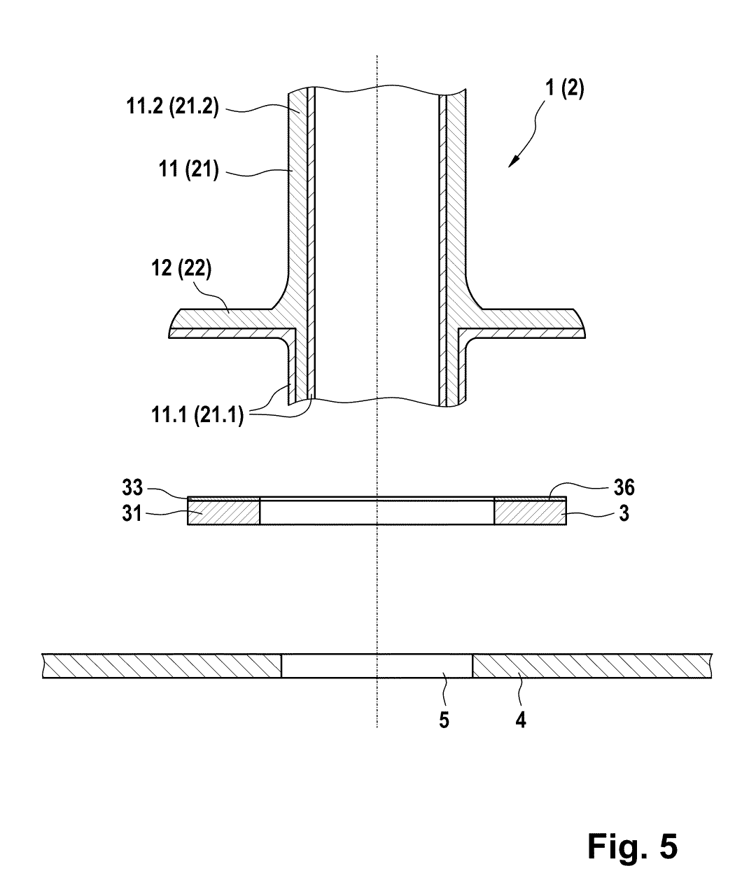

FIG. 5 provides a partial, schematic, disassembled, sectional view illustrating a third embodiment of an attachment of a tubular body element of a filler neck as in FIG. 1 or tank venting valve as in FIG. 2;

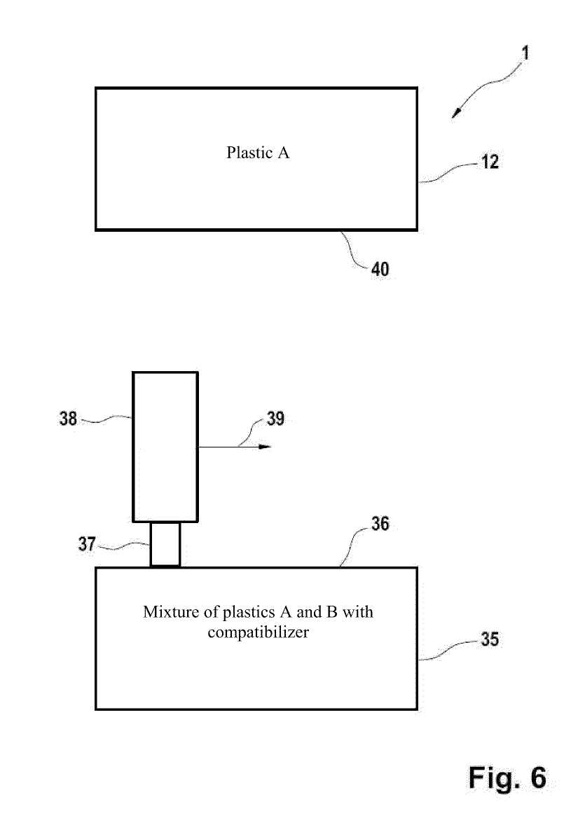

FIG. 6 illustrates embodiments of a first component and of a second component during a pretreatment before integral bonding;

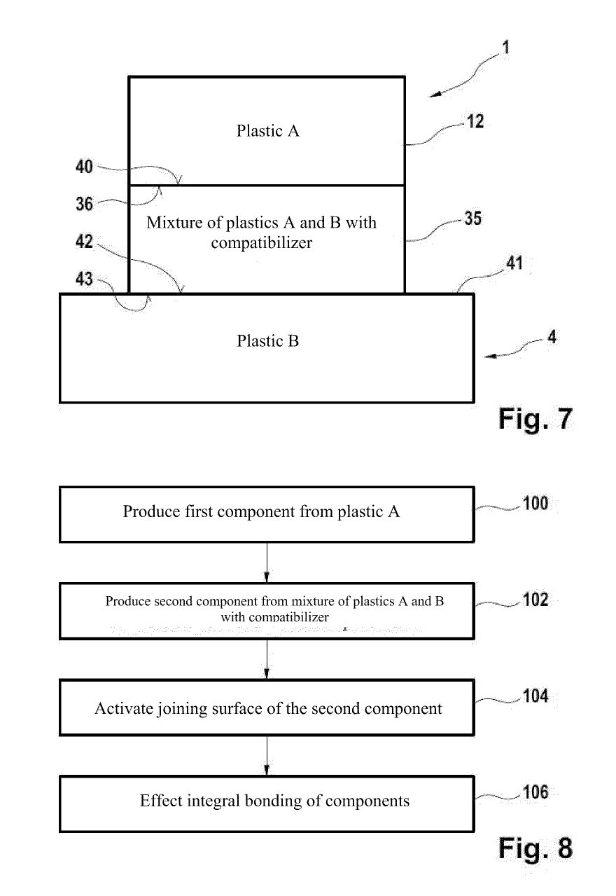

FIG. 7 illustrates embodiments of a fuel tank according to the invention comprising a fuel tank attachment;

FIG. 8 illustrates embodiments of a method according to the invention for producing a fuel tank attachment.

Elements of the following figures that match are generally identified by the same reference number.

FIG. 6 is schematic view illustrating a first component 12 of an embodiment of a fuel tank attachment 1 according to the invention. First component 12 is essentially composed of a first plastic A that is fuel-resistant. Plastic A may be, for example, PA, in particular, PA 12, POM, or another fuel-resistant thermoplastic material.

The fuel tank attachment furthermore has a second component 35 that is composed essentially of a blend of plastic A and plastic B. Plastic B is a non-fuel-resistant plastic which is not miscible with plastic A.

Plastic B is, for example, PE, in particular high-density PE (HDPE), polypropylene (PP), or another thermoplastic non-fuel-resistant material. In order to effect the miscibility of plastics A and B, the blend contains a compatibilizer, such as, for example, a copolymer of plastics A and B; if plastic A is PA and plastic B is PE, then the copolymer may, for example, be PEgPA (g=graft), that is, a grafted copolymer. The grafted copolymer is produced by, for example, providing the PE with a reactive group—for example, maleic anhydride or an acetic acid group, and whereby the thus grafted PE then enters into covalent bonds with the PA. Conversely, however, the PA may also be grafted in order then to subsequently enter into covalent bonds with the PE.

In order to effect an integral bonding of first component 12 with second component 35, one joining surface 36 of component 35 undergoes a pretreatment. In the embodiment considered here, the pretreatment is effected by applying a plasma 37 to joining surface 36. Plasma 37 flows out of a plasma jet 38 onto joining surface 36, where plasma jet 38 is moved in the direction of arrow 39 along joining surface 36 such that the entire joining surface 36 is covered by plasma 37.

The application of plasma 37 to joining surface 36 enhances its reactivity. This facilitates the creation of an integral bond between components 12 and 35 due to the fact that, for example, one joining surface 40 of component 12 and joining surface 36 are plasticized by a plastic welding process.

Components 12 and 35 can also be produced by two-component or multi-component injection-molding processes. To do this, for example, component 35 is produced first by injecting the blend with the compatibilizer into a mold. After the blend solidifies, the mold is opened and joining surface 36 of the thus-obtained component 35 is subjected to a pretreatment—for example, application of plasma 37. After this pretreatment, the mold is closed again and plastic A is injected into the mold to produce component 12. During the process of injecting hot plastic A, component 35 is plasticized at its joining surface 36, thereby creating an integral bond with component 12 there.

The result of this integral bonding of components 12 and 35 is the finished fuel tank attachment 1 that can then be installed in its functional position on a fuel tank.

FIG. 7 is a schematic view illustrating one embodiment of fuel tank attachment 1 in its functional position in which it is installed on a fuel tank 4. Components 12 and 35 are integrally bonded to each other along joining surfaces 40 or 36.

Fuel tank 4 has an outer wall 41 that is composed essentially of plastic B. Since the blend of which component 35 is composed also contains plastic B, effecting an integral bond between component 35 and outer wall 41 is possible. This integral bond can be implemented with or without a pretreatment of one or both relevant joining surfaces, i.e., of one joining surface 42 of component 35 and one joining surface 43 created on outer wall 41. It is possible, specifically, to dispense with this pretreatment of joining surface 42 of component 35, or of joining surface 43 of outer wall 41, when the proportion of plastic B in the blend is greater than the proportion of plastic A.

FIG. 8 shows a flow chart for an embodiment of a production process according to the invention.

A first component of the fuel tank attachment composed of plastic A is produced in step 100. In step 102, a second component of the fuel tank attachment is produced from a blend of plastics A and B, wherein the blend contains a compatibilizer to make plastics A and B miscible.

In step 104, an optional pretreatment of one joining surface, preferably of the second component, is effected to activate this joining surface, that is, to make it chemically more reactive. This pretreatment can be effected by a plasma treatment, plasma deposition, flame treatment, chemical etching, and/or a mechanical pretreatment of the joining surface. Alternatively or additionally, the joining surface of the first component can be subjected to this type of pretreatment.

If plastic B happens to be the less reactive plastic, as is the case, for example, when plastic B is PE and plastic A is PA, what is then preferably implemented is the pretreatment of the joining surface of the second component, in particular so as to make the less-reactive portion of plastic B in the blend more reactive.

In step 106, the first and second components are integrally bonded to each other.

Production of the first component in step 100 and production of the second component in step 102 can proceed in separate procedural steps by means of different injection molds. In this case, the first and second components fabricated by means of separate molds and subsequently bonded in step 106.

Alternatively, production of the first and second components can be effected by two-component or multi-component plastic injection molding in a single mold. For example, plastic A is first injected into the mold to produce the first component. Then the blend of plastics A and B is injected along with a compatibilizer into the same mold to produce the second component. Before injection, an activation is optionally performed on the already produced joining surface of the first component. Injection of the plasticized blend of plastics A and B with the compatibilizer results in an integral bond between the first and second components.

Alternatively, it is also possible to first inject the blend of plastics A and B with the compatibilizer into the mold to produce the second component. Optionally after this, a joining surface of the second component is activated in the mold by a pretreatment, for which purpose it may be necessary to open the mold. The mold is then re-closed and plastic A is injected to produce the first component, and at the same time effect the integral bond with the second component.

The following discussion describes some detailed embodiments of the fuel tank attachment of FIGS. 6 and 7.

Tanks for fuel, that is, fuel tanks, have become increasingly complex in terms of their shaping so as to provide the greatest possible volumetric capacity within confined spatial conditions. The shaping varies considerably depending on the vehicle type. Components, such as the filler neck or valves, are therefore prefabricated individually in a separate process and only later mounted on the tank during final assembly. The tanks generally are composed of multiple layers, of which the outer most layer is composed of polyethylene.

FIG. 1 shows a filler neck 1 that has a tubular body element 11 along with a annular body element 12. The fuel tank attachment (see FIGS. 6 and 7) is here designed as a filler neck. The first component here is a tubular body element 11 with an annular body element 12.

An annular flange body 3 of thickness D is disposed below annular body element 12, which body is the second component (see component 35 of FIGS. 6 and 7). Flange body 3 is located above an opening 5 of tank 4. In the region of opening 5, annular body element 12 of tubular body element 11 is at a distance a from tubular outlet opening 18, which distance is greater than thickness D of the flange body. As a result, tubular body element 11 projects into opening 5 of tank 4. In addition, an outer diameter dR of tubular body element 11 is approximately the same size as an inner diameter dB of the opening, yet smaller than an inner diameter dF of flange body 3 (see also FIG. 3). Located at the opposite end of tubular body element 11 is a connection unit with a circular retaining ridge 13.

A valve element 2 shown in FIG. 2 has a tubular body element 21 with an annular body element 22.

Annular flange body 3 of thickness D is also disposed below annular body element 22. The fuel tank attachment (see FIGS. 6 and 7) is also designed here as a valve element 2. The first component here is a tubular body element 21 with annular body element 22. Flange body 3 is the second component (see component 35 of FIGS. 6 and 7).

The flange body is located over opening 5 of tank 4. In the region of opening 5, annular body element 22 of tubular body element 21 also is at a distance a from its end, which distance is significantly greater than thickness D of flange body 3. As a result, tubular body element 21 projects far into opening 5 of tank 4. Tubular outlet openings 28 are disposed at the end of tubular body element 21. In addition, the outer diameter dR of tubular body element 21 is approximately the same size as inner diameter dB of the opening, yet smaller than the inner diameter dF of flange body 3 (see also FIG. 3).

The opposite end of tubular body element 21 is closed by a cap element 24. Connecting tubular elements 25 and 26 with at least one circular retaining ridge 23.1, 23.2, 23.3, 23.4 are disposed on tubular body element 21 below the cap element. A valve element 27 is disposed in this thus-prepared housing.

The problem to be solved now exists of attaching a first component in the form of a filler neck or a valve unit on tank 4 over opening 5.

If the first component and outer wall 41 of tank 4 are composed of non-compatible thermoplastic materials, a second component is inserted as a connection adapter to effect attachment of the first component to outer wall 41. The connection adapter fulfills the function, on the one hand, of creating a fluid-tight connection to the first component, and, on the other hand, creating such a connection with tank 4.

Filler neck 1 of FIG. 1 and valve unit 2 of FIG. 2 are of similar design in the region of tubular body element 11, 12, annular body element 12, 22 (first component), and annular flange body 3 (second component). The annular body element here emerges in a lug-like fashion from the tubular body element. The bottom surface element of the annular body element is essentially flat. The outer transitions are rounded, while the inner wall is continuously smooth.

Various embodiments of parts 1 and 3 are shown in FIGS. 3 through 5.

FIG. 3 illustrates a first embodiment. Tubular body element 11, 21, and annular body element 12, 22 are composed of polyamide—hereafter PA. The outer layer, i.e., outer wall 41, of multilayer tank 4, as was already mentioned, is composed of polyethylene—hereafter PE.

Flange body 3, i.e., the second component, is composed of a blend of PE and PA along with a graft copolymer PEgPA as the compatibilizer, and is designed as copolymer—flange body 31. The blend can have additives such as stabilizers, lubricants, metallic pigments, and the like.

One surface element of flange body 3, i.e., its joining surface 36, is then pretreated. This can be effected, for example, by a plasma treatment or a plasma coating, by which a layer 33 is applied. The thickness of the layer can be approximately 0.001 μm up to 100 μm. After pretreatment, flange body 3 and tubular body element 11, 21 undergo integral bonding to each other at joining surfaces 40, 36.

A second embodiment is shown in FIG. 4. Tubular body element 11, 12, and annular body element 12, 22 are composed of a cup-shaped PA—partial body 11.1, 21.1., i.e., the first component around which a partial body 11.2, 21.2 is formed over the annular body element. Partial body 11.2, 21.2 is the second component composed of a blend of PE and PA with a grafted PEgPA copolymer as the compatibilizer. Partial body 11.2, 21.2 is integrally bonded to tubular body element 11, 21.

The outer layer, i.e., the outer wall of multilayer tank 4 is composed here of PE.

Flange body 3 is an additional second component that is designed as copolymer—flange body 31. It is composed of the blend of PE and PA with a grafted PEgPA copolymer as the compatibilizer, and optionally additives such as stabilizers, lubricants, metallic pigments, and the like.

FIG. 5 illustrates a third embodiment. Tubular body element 11, 21 and annular body element 12, 22 are composed of a partial body 11.2, 21.2, i.e., the second component in the form of a core body which, at least on the surfaces exposed to fuel vapors or fuel, is coated, i.e. integrally bonded, with PA—partial bodies 11.1, 21.1, i.e., the first components.

The outer layer, i.e., outer wall 41, of multilayer tank 4 is composed of PE. Flange body 3, which is an additional second component, is designed as copolymer—flange body 31.

The production and attachment of the component as a filler neck 1 in FIG. 1, or of the component as a tank venting valve 2 in FIG. 2, will be described based on FIG. 3.

First, tubular body element 11, 21 with annular flange body element 12, 21 (first component) is formed from PA.

With filler neck 1, tubular body element 11 terminates in circular retaining ridge 13. The opposite end 28 is of just sufficient length from the bottom edge of the flange body element that it is able to extend a short way beyond the inner wall of tank 4 into the tank.

With tank venting valve 2, on the other hand, tubular body element 21 is closed by cap element 24. Connecting tubular elements 25, 26 with retaining ridges 23.1, . . . , 23.4 are molded onto tubular body element 21 below the cap element. The end of tubular body element 21 opposite cap element 24 is of sufficient length that it is able to project far into the tank and can accommodate the valve element 27 in its interior. In order to enable gases to flow unobstructed into the valve element, tubular outlet openings 28 are molded in.

Flange body 3 (second component) is then formed from the blend of PE and PA with a grafted PEgPA copolymer as the compatibilizer.

The first and second components are then formed by injection molding. Joining surface 36 is then plasma-treated, thereby forming layer 33.

The plasma is a blend of positive and negative charge carriers in relatively large concentration, neutral particles, and photons. The concentrations of positive ions and electrons here are sufficiently stable that on average over time compensate each other at every point. The plasma should be conceived of as a separate aggregate state.

In plasma generation, a discharge is triggered in a gas atmosphere, e.g., air and its compounds, or in an inert-gas atmosphere, e.g., helium, neon, argon, krypton, xenon, radon, and combinations thereof. The ions are extracted from the plasma by the carrier, i.e., joining surface 36 as the target, i.e., layer material that is atomized thereby. At the same time, ions are generated in the ion source and accelerated a short distance and directed as a beam onto surface element 36. As a result, layer 33 grows under open conditions.

It is also possible, however, for components to be contained in a gas, in particular, air, which components react in the open state at joining surface 36 and form layer 33. The components may be of an organic or inorganic type. Layer 33 is thus applied in the already-referenced thickness range of between approximately 0.001 μm to 100 μm.

The first and second components are then welded together. Alternatively, production is effected by means of two-component injection molding.

As a result, both filler neck 1 and tank venting valve 2 are ready for attachment to tank 4 and are sent on to final assembly.

Once arrived at the point of use, filler neck 1 and tank venting valve 2 are welded on at opening 4 provided for them on the tank composed of PE. It is advantageous in terms of assembly that all components here are provided with the same connection adapter. Filler neck 1 and tank venting valve 2 are joined to tank 4 in a fluid-tight manner due to their shape and plastics.

The volumetric expansion indices

PE<PE/PA<PA

are selected such that the integral bonds reliably withstand any possible swelling since it is possible for swelling to occur—if only to a small degree—even in a fuel-resistant plastic.

1-39. (canceled)

40. A fuel tank attachment, comprising:
a first region that is composed of a first plastic that is fuel-resistant, and
a second region that is composed of a mixture of the first plastic and a second, polyethylene (PE), plastic that is non-fuel-resistant, and the second region is integrally bonded to the first region through a first joining surface, wherein:
the mixture contains a compatibilizer of a maximum of 15 weight %, which compatibilizer is a copolymer of the first plastic and the second plastic, to make the first and second plastics miscible, where otherwise they would not be, and
the second region is designed to undergo integral bonding with a third region through a second joining surface, the third region being composed of a third plastic and being located at an outer wall of a fuel tank.

41. The fuel tank attachment according to claim 40, wherein the copolymer is a graft copolymer.

42. The fuel tank attachment according to claim 40, wherein the copolymer has an added compatibilizer.

43. The fuel tank attachment according to claim 40, wherein a proportion of the first plastic in the mixture is lower than a proportion of the second plastic.

44. The fuel tank attachment according to claim 43, wherein the proportion of the first plastic is one of: (i) a maximum of 35 weight %, (ii) between 20 wt. % to 30 wt. %.

45. A motor-vehicle fuel tank, comprising:
at least one fuel tank attachment, including:
a first region that is composed of a first plastic that is fuel-resistant, and
a second region that is composed of a mixture of the first plastic and a second, polyethylene (PE), plastic that is non-fuel-resistant, and the second region is integrally bonded to the first region through a first joining surface, wherein:
the mixture contains a compatibilizer of a maximum of 15 weight %, which compatibilizer is a copolymer of the first plastic and the second plastic, to make the first and second plastics miscible, where otherwise they would not be, and
the second region is designed to undergo integral bonding with a third region through a second joining surface, the third region being composed of a third plastic and being located at an outer wall of a fuel tank.

46. A method of producing a fuel tank attachment, comprising the steps of:
producing a first component from a first plastic that is fuel-resistant polyamide (PA);
producing a second component from a mixture of the first plastic, a second plastic that is a non-fuel-resistant polyethylene (PE), a compatibilizer so as to make the first and second plastics miscible; and
welding an integral bond between the first and second components,
wherein the compatibilizer is a copolymer of the first plastic and second plastic in a proportion in the mixture of a maximum of 15 weight %.

47. The method according to claim 46, wherein the copolymer is a graft copolymer.

48. The method according to claim 47, wherein the second plastic is grafted to produce the graft copolymer so as to then enter into covalent bonds with the first plastic.

49. The method according to claim 46, wherein one joining surface of the second component is subjected to a pretreatment before integral bonding.

50. The method according to claim 49, wherein the pretreatment comprises one or more of the following measures:
plasma treatment,
plasma coating,
flame treatment,
chemical etching,
mechanical pretreatment, and
roughening.

51. The method according to claim 46, wherein the fuel tank attachment is produced by two-component or multi-component plastic injection molding processes, wherein first the second component is produced by injecting the mixture into a mold, and wherein the second component is produced subsequently and the integral bond with the first component is effected by injecting the first plastic into the mold.

52. The method according to claim 51, wherein a joining surface of the second component is subjected to a pretreatment before the first plastic is injected.

53. The method according to one of the foregoing claim 46, wherein an additional compatibilizer is used to produce the copolymer, the compatibilizer being added in solid or liquid form to a mixture of the first plastic and the second plastic and being at least partially consumed during copolymerization.

54. The method according to claim 53, wherein the additional compatibilizer contains reactive isocyanate groups and/or oligomers with epoxide groups and/or (maleic) anhydride groups or oxazoline groups.
